SEQUENCE LISTING (2 sequences)

SEQ ID NO: 1 - DNA, 15 bp, Artificial
  Synthetically generated oligonucleotide
gttaccacacggatg

SEQ ID NO: 2 - DNA, 15 bp, Artificial
  Synthetically generated oligonucleotide
catccgtgtggtaac

(19) United States
(12) Patent Application Publication
(10) Pub. No.: US 2006/0197952 A1
(43) Pub. Date: Sep. 7, 2006

(54) Surface plasmon resonance sensor with high sensitivity

(76) Inventors: Shean-Jen Chen, Jungli City (TW); Chun-Yu Lin, Shalu Jen (TW); Fan-Ching Chien, Taoyuan City (TW); K.T. Huang, Fengshan City (TW); W.P. Hu, Chishan Jen (TW); Wen-Yih Chen, Jungli City (TW); Kuan-Ching Lee, Jungli City (TW); Wen-Hsien Li, Jungli City (TW)

Correspondence Address: LIN & ASSOCIATES INTELLECTUAL PROPERTY, P.O. BOX 2339, SARATOGA, CA, 95070-0339, US

(21) Appl. No.: 10/660,833

(22) Filed: Sep. 12, 2003

(30) Foreign Application Priority Data
Jan. 23, 2003 (TW) 092101484

(51) Int. Cl. G01N 21/55

(52) U.S. Cl. 356/445

(57) ABSTRACT

A high-sensitivity SPR (surface plasmon resonance) sensor includes at least a prism having a first surface on which a metallic layer and a metallic nanoparticle layer are sequentially formed. A light source projects an incident light into the prism through a second surface of the prism. The light is reflected by the metallic layer and the metallic nanoparticle layer and leaves the prism through a third surface of the prism. A light detector detects the reflected light. The SPR sensor has an extensive detection range as compared with the conventional ones and is applicable in the detection of gas, chemical substance, and biomolecule. Moreover, the SPR sensor is advantageous in arranging fabrication process consistently, controlling film thickness, improving product quality, and decreasing fabrication cost.

### BACKGROUND OF THE INVENTION

1. Field of the Invention

The present invention relates generally to a surface plasmon resonance (SPR) sensor, specifically to a high-sensitivity SPR sensor of nanoparticle.

2. The Prior Arts

The so-called surface plasmon resonance (SPR) is a phenomenon, in which a zero-intensity reflecting light, or a zero-reflectivity metallic film in other words, is found by a light detector, when a light beam is incident upon a metallic surface by a designated incident angle. The un-reflected light propagates along the reflection interface at a specific speed, exciting SPR of the metallic surface, which is often referred to as Attenuated Total Reflection (ATR).

A SPR sensor is constructed on the basis of the SPR phenomenon by way of coating a gold (or silver) film on a surface of a prism on which ligand binding to an analyte is immobilized or adsorbed. When the ligand is binding to the analyte, the SPR phenomenon changes, which allows for detection of the analyte concentration and the binding interaction between the ligand and the analyte.

The SPR sensor is extremely sensitive, is able to detect an analyte without labeling (labeling free) for a rapid real-time analysis of molecular interaction, quantification, and massive screening for the analytes. The SPR sensor is applied extensively for detecting bio-molecules, practically for detecting the interaction between antigen and antibody, enzyme and substrate, hormone and receptor, and between nucleic molecules, or cooperating with biochips to build a platform for screening new medicines. In addition, the SPR sensor could be applied to environmental engineering, such as gas detection, chemicals detection, waste water detection, and pollution monitoring.

A known SPR sensor of Kretschmann configuration is built by coating a metallic film on a surface of a prism and applied to detect an analyte (air or solution) through a detecting mechanism of prism-metallic film-analyte. Such a detecting mechanism is defective in its sensitivity and limited capability for observing only the intensity change of electric field vibrating component parallel with transverse-magnetic (TM) light waves in an incident surface.

Besides, a SPR sensor of coupled plasmon-waveguide resonance (CPWR) disclosed in U.S. Pat. No. 5,991,488 by Salamon and others is built by interpolating a dielectric layer between a metallic membrane and an analyte for heightening sensitivity and spectrum-analyzing ability and for adsorbing or immobilizing the ligand binding to the analyte thereby broaden the application scope thereof. Moreover, a long-range surface plasmon resonance (LRSPR) sensor of plasmon-waveguide coupled multi-layer film is enabled not only to detect changes of transverse magnetic and transverse electric light waves but also to narrow the adsorption spectra for sharp measurements, and further, for raising the resolution and sensitivity of the sensor.

Unfortunately, however, the sensitivity of the SPR sensor available until now is far from satisfaction with respect to low-concentration detection of the analytes. Taking a SPR biosensor for instance, the detection limit thereof is about 1 pg/mm² of biomolecular surface coverage. Lower than this concentration, the sensor is found disabled to detect the biomolecular interactions.

Accordingly, for securing the effect of Surface Enhanced Raman Scattering (SERS) on surface of a metallic film so as to improve the sensitivity of a SPR sensor, Natan and Baker disclose in U.S. Pat. No. 6,242,264 a Self-Assembled Metal Colloid Monolayer created by reacting a substance (glass or metal) containing a functional group, such as hydroxyl or oxide, with organosilane, then immersing it into a solution having colloid of metallic nanoparticles in order to reinforce Raman scattering. As immersing has to be repeated several times, the process is complicated and the film thickness cannot be controlled easily.

In viewing above said, the present invention is elaborated in the hope to present a SPR sensor capable of expanding application field for detecting infinitesimal substances on the one hand while simplifying the fabrication process and lowing the cost on the other.

### SUMMARY OF THE INVENTION

A primary object of the present invention is to provide a surface plasmon resonance (SPR) sensor with high sensitivity, in which a metallic nanoparticle layer is capable of enhancing the phenomenon of surface electromagnetic radiation so as to enhance the detecting sensitivity of the sensor significantly.

Another object of the present invention is to provide a method for manufacturing a high-sensitivity SPR sensor, in which a co-sputtering process is applied for coating a metallic nanoparticle layer on the SPR sensor to control film thickness and facilitate massive production.

In order to realize the foregoing objects, the SPR sensor of the present invention comprises an incident light source, a prism, a metallic layer adjacent to the prism, a metallic nanoparticle layer adjacent to the metallic layer, and a light detector for detecting reflecting light.

In building the high-sensitivity SPR sensor, a metallic thin layer is first coated on the prism by way of sputtering or vapor plating. At this time, as a conventional spin-coating method which is supposed to mix metallic nanoparticles with dielectric substance to form a film on the metallic layer is reluctant to control of film thickness, instead, the present invention takes a dielectric substance and a metal for forming metallic nanoparticle layer as a target and uses RF magnetron sputtering system to blend the dielectric substance with the metallic particles and have it deposited on the metallic layer to form a metallic nanoparticle layer by such a simple process, which is also preferable for film-thickness control. Preferably, the RF magnetron sputtering system could be adopted for building both the metallic thin layer and the metallic nanoparticle layer when the whole fabrication process is put into consideration.

After the foregoing metallic nanoparticle layer is finished, the SPR effect is excited and the effect of electromagnetic radiation is enhanced to thereby heighten the sensitivity of the SPR sensor. Besides, as the metallic nanoparticle layer is deemed possibly to widen the absorption spectra to deteriorate resolution, the dielectric substance is introduced to narrow the widened absorption spectra to further enhance the detecting resolution of the SPR sensor.

Again, the given SAM (self assembled monolayer) is to provide different functional groups or molecules according to uses' requirements such that the ligand or probe binding to the analyte can be immobilized or adsorbed on surface of the sensor for detection.

In addition, noise can be reduced to enhance S/N ratio by adjusting polarized lights to excite or suppress some specific vibrating or rotating modalities.

Also, the light detector is preferably designed to detect the SPR and light interference of TM and TE light waves simultaneously for filtering out the background noise effectively to improve accuracy of detection.

For more detailed information regarding advantages and features of the present invention, examples of preferred embodiments will be described below with reference to the annexed drawings.

### BRIEF DESCRIPTION OF THE DRAWINGS

The related drawings in connection with the detailed description of the present invention to be made later are described briefly as follows, in which:

FIG. 1 is a schematic view showing a surface plasmon resonance (SPR) sensor with high sensitivity in accordance with the present invention;

FIG. 2 is a schematic view showing a SPR sensor of the present invention;

FIG. 3 shows the enhanced Raman scattering spectra of metallic nanoparticle layers;

FIG. 4 shows spectral curves of various structures of film layers;

FIG. 5 shows data comparison of detected gases made by a conventional SPR sensor and the present invention;

FIG. 6 is a schematic view of a biosensor based on the layer structure of the present invention;

FIG. 7A shows detection of DNA hybridization with SPR sensor of the present invention. The solution is flowed through the surface of SPR sensor with time in the following manner. 0˜90 min: Mobile phase (20 mM phosphate buffer solution (PBS, pH 7.7) containing 300 mM of sodium chloride, 1 mM of EDTA and 100 mM of urea); 90˜300 min: Mobile phase containing 1 μM of DNA which sequence is SEQ ID NO: 2; 300 min˜: Mobile phase; and

FIG. 7B shows detection of DNA hybridization with conventional SPR sensor. The solution is flowed through the surface of SPR sensor with time in the following manner. 0˜30 min: Mobile phase (20 mM phosphate buffer solution (PBS, pH 7.7) containing 300 mM of sodium chloride, 1 mM of EDTA and 100 mM of urea); 30˜135 min: Mobile phase containing 1 μM of DNA which sequence is SEQ ID NO: 2; 135 min˜: Mobile phase.

### DETAILED DESCRIPTION OF THE PREFERRED EMBODIMENT

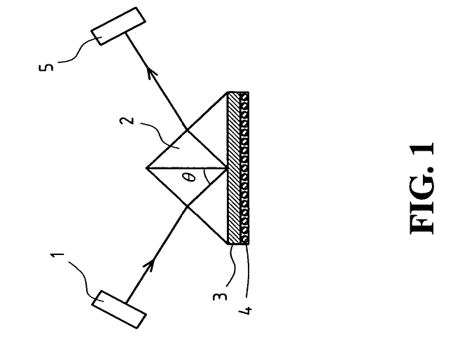

Several preferred embodiments of the present invention are described in detail below with reference to the drawings annexed, in which FIGS. 1, 2, and 6 are not drawn to scale.

### EXAMPLE 1

### Surface Plasmon Resonance (SPR) Sensor with High Sensitivity

As indicated in FIG. 1, a SPR sensor comprises an incident light source (1), a prism (2), a metallic layer (3), a layer of metallic nanoparticle layer (4), and a light detector (5).

The metallic layer (3) having a thickness of about 50 nm is formed on a surface of the prism (2) by way of for example RF magnetron sputtering method for precisely controlling the film thickness thereof, or alternatively, by co-sputtering or vapor-plating method generally employed to form metallic films. The material adopted for the metallic layer (3) is gold or silver.

The layer of metallic nanoparticle (4) having a thickness of 1-50 nm is formed on the metallic layer (3) by way of RF magnetron sputtering method using dielectric substance and the metal for creating metallic nanoparticles as the target for being mixedly deposited on the metallic layer (3) to form the metallic nanoparticle layer. Alternatively, the solution of a dielectric substance (usually a polymer) containing metallic nanoparticles is applied by spin coating method to form a film on the metallic layer (3). The material adopted for the metallic nanoparticle layer (4) is gold or silver or platinum, and the diameter of the grains is 1-50 nm approximately.

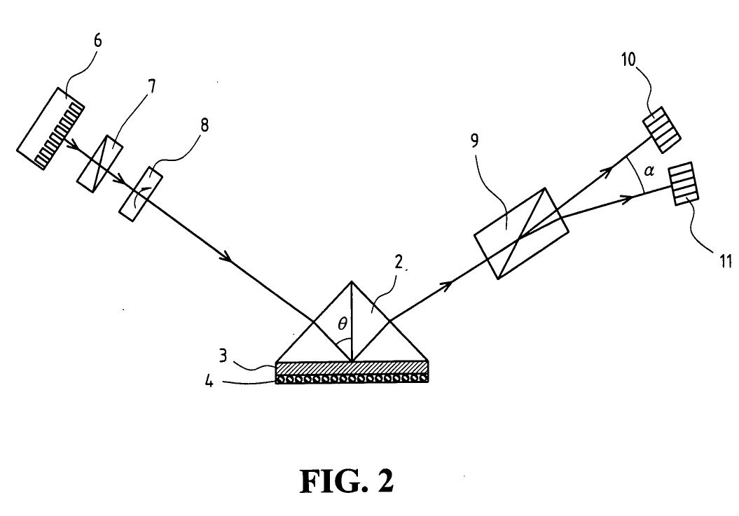

With regard to the incident light source, a generic laser beam is applicable, or, instead, a laser diode array (6), which radiates multiple laser beams as shown in FIG. 2 whose polarized components of light are adjusted by a polarizer (7) and a half-wave plate (8) and a platform of the plate (8) rotating at a constant speed to guide the incident light to shoot on the prism (2) is feasible. In such a mechanism, since different polarized light beams may excite different vibrating or rotating modalities of substance, some polarized light beam may be used to enhance or suppress a modality to thereby further decrease noise for heightening S/N ratio.

As to the light detector (5), a photodiode or a CCD (charge coupled device) sensor of commercial grade may serve for the purpose well by using a Wollaston prism (9) to split a reflecting beam into a transverse magnetic (TM) and a transverse electric (TE) polarized beam perpendicular to each other, then using a linear array photodiode (10,11) to receive reflecting beams and analyze multiple sets of information rapidly and synchronously by taking advantage of angle-polling and different acceptor-arrays such that the enlarged background noise can be filtered effectively for raising the accuracy of measurements.

### EXAMPLE 2

### Enhanced Raman Scattering Spectra of Metallic Nanoparticles

After different configurations including sliver layer, silver nanoparticle layer, and monolayer of crystal violet are coated on different prisms in sequence from the bottom to the top thereof to form respective test specimens:
(A) Prism (glass), metallic layer (silver layer), metallic nanoparticle layer (silver nanoparticle layer), and then monolayer of crystal violet;
(B) Prism (glass), metallic nanoparticles (silver nanoparticles), and then monolayer of crystal violet;
(C) Prism (glass), metallic layer (silver layer), mono-layer of crystal violet, and then metallic nanoparticles layer (silver nanoparticles); and
(D) Prism (glass), metallic layer, and then monolayer of crystal violet.

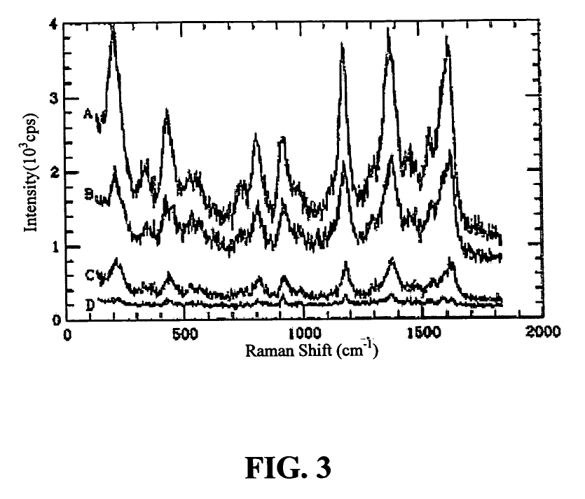

Different patterns of Raman scattering can be observed as shown in FIG. 3. When compared with each other, the configuration of specimens A, B, and C containing a silver nanoparticle layer are all found capable of enhancing the effect of electromagnetic radiation as higher as times of decades than that without the same layer. Therefore, the fact that the metallic nanoparticle layer coated on a SPR sensor can greatly enhance the effect of electromagnetic radiation is corroborated.

### EXAMPLE 3

### Comparison of SPR Sensors Having Respective Layer Structures

Different layer structures formed on SPR sensors according to the method described in example 1 from the bottom to the top of prisms are listed below as:
(A) Prism (glass), then a metallic layer (golden layer);
(B) Prism (glass), metallic layer (golden layer), then, dielectric layer (silicon dioxide layer);
(C) Prism (glass), metallic layer (golden layer), then, metallic nanoparticle layer (gold nanoparticle layer); and
(D) Prism (glass), metallic layer (golden layer), metallic nanoparticle layer, then, dielectric layer (silicon dioxide layer).

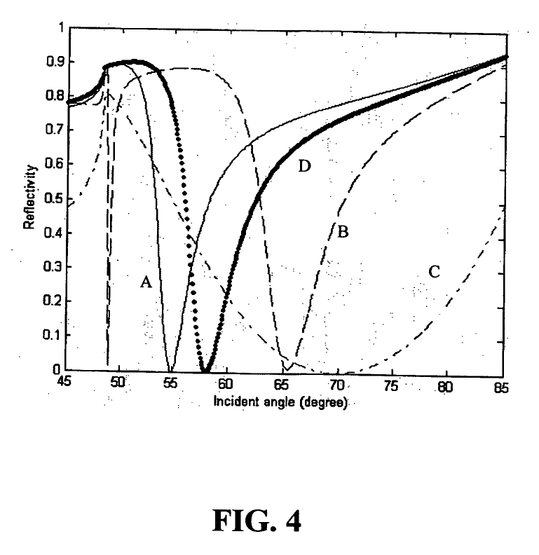

After different films are coated on respective SPR sensor, water, as an analyte, is flowed through the surface of the SPR sensor for measuring respective reflectivity. As indicated in FIG. 4—plotted curves of spectra based on different incident angle vs. reflectivity of SPR sensor—the metallic nanoparticle layer has significantly expanded the effect of electromagnetic radiation as expected according to example 2 though, the spectral curves are, on the contrary, widened to have resolution deteriorated (shown in curve C). However, this defect could be improved to some extents by adding one more dielectric layer on the layer structure C for narrowing the widened spectral curves (shown in curve D) and heightening accordingly the detecting resolution of the SPR sensor.

### EXAMPLE 4

### Using SPR Sensor with High Sensitivity of the Present Invention to Detect Gas

A conventional SPR sensor (A) and a SPR sensor of the present invention (B) represent two sensors coated with respective layer structures, namely:
(A) Prism (glass), and then metallic layer (golden layer); and
(B) Prism (glass), metallic layer (golden layer), and then metallic nanoparticle layer (gold nanoparticle layer).

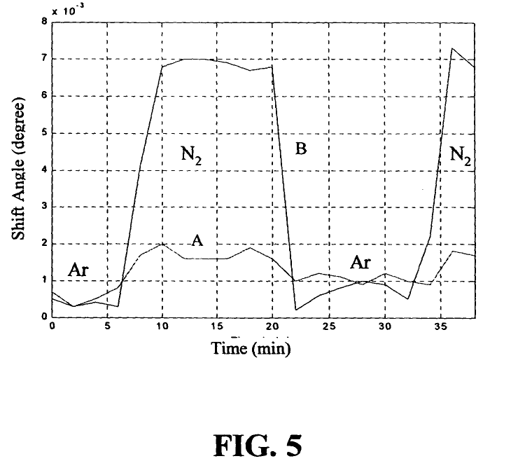

After the SPR sensors are coated with foregoing layer respectively and in certain period of time, argon and nitrogen are guided alternately to flow through the surface of those two SPR sensors. FIG. 5 is plotted to show SPR shift angle on time basis that can highly discriminate those two analyzed gases from each other than a conventional one can do, in which, particularly, the SPR shift angle with respect to nitrogen detected by the SPR sensor of the present invention is about three times higher than that detected by the conventional one. Hence, the SPR sensor of the present invention is confirmed applicable to gas detection and is further sensitive than a conventional sensor.

### EXAMPLE 5

### A Biosensor Based on the Layer Structure of the Present Invention

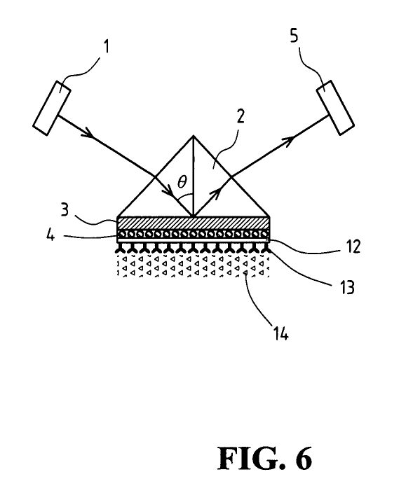

FIG. 6 is a schematic view of a biosensor based on the layer structure of the present invention.

After a prism (2) is coated with a metallic layer (3) and a metallic nanoparticle layer (4) in sequence according to the manner described in example 1, a SAM layer (12) is deposited on top of the formed layers. Thereafter, a ligand or probe (13) for binding the analyte (14) is immobilized or adsorbed onto the SAM layer for detecting the analyte (14).

In response to users' practical requirements, the SAM layer (12) may be built by a usual way for constructing a SAM layer so as to provide different functional groups or molecules, such as group of SH, NH₂, CHO, COOH, or Biotin, for bonding or adsorbing the ligand or probe (14) to binding the analytes.

The foregoing ligand or probe (14) for binding an analyte could be an antigen, antibody, enzyme, hormone, receptor, nucleic acid and the likes, and by detecting interaction between those ligand and a corresponding analyte, the concentration of analyte and kinetics of interaction between molecules interested. Besides, the present invention is merited in massive parallel screening and technical cooperation with biochips for building up a platform for screening new medicines.

In short, by taking advantage of the metallic nanoparticle layer and the dielectric layer, sensitivity and resolution of the SPR sensor of the present invention can be significantly raised. Moreover, signal to noise (S/N) ratio of the SPR sensor can be either reduced or raised further by matching with the conditions of the incident light source and the light detector. In addition, all the layers of the high-sensitivity SPR sensor of the present invention can be plated by a sputtering method for easy control of film thickness, better uniformity, and lower fabrication cost.

In the above described, it is apparent that numerous changes or modifications may be made without departing from the true spirit and scope thereof, as set forth in the claims below.

### EXAMPLE 6

### Using High-Sensitivity SPR Sensor of the Present Invention to Detect DNA Hybridization

A SPR sensor of the present invention and a conventional SPR sensor are prepared to detect DNA hybridization in the following manner. A SPR sensor (A) is fabricated according to the device of SPR biosensor described in example 5, a conventional SPR sensor (B) is fabricated in the same way but without metal nanoparticle layer.

A 15 mers of DNA which sequence is SEQ ID NO: 1 is employed as a probe DNA. Fabrication of DNA probe on sensor (A) is carried out in the following manner. A solution which is prepared by mixing equivalent volume of concentrated sulfonic acid and 30% of hydrogen peroxide is dropped and stayed onto the surface of metallic nanoparticle layer of sensor (A) for 2 minutes at room temperature. The treated surface of sensor (A) is rinsed with de-ionized water, ethanol and dried with pure nitrogen. A Solution containing (3-aminopropyl) triethoxysilane (APTES) and ethanol is dropped onto the treated surface of sensor (A), and then the surface is rinsed with ethanol and dried with pure nitrogen. The sensor is immersed into a solution containing 1 μM of DNA probe, 1 mg/ml of N-ethyl-N′-(3-dimethylaminopropyl) carbodiimide hydrochloride (EDC hydrochloride) and 40 mM of 2-(N-Morpholino) ethanesulfonic acid (MES) at room temperature overnight to immobilize the DNA probe onto the surface of sensor (A). The surface of sensor after immobilization of DNA probe is rinsed with de-ionized water and immersed into methanol overnight. The sensor (A) with DNA probe is rinsed with de-ionized water and stored in the MES buffer at 4° C. prior to use.

Fabrication of DNA probe on sensor (B) is carried out by immersing the surface of metallic layer of sensor (B) into a solution containing 1 μM of DNA probe, 1 mg/ml of EDC hydrochloride and 40 mM of MES buffer. The sensor is immersed into methanol to replace the unreacted EDC molecules after fabrication of DNA probe. The sensor is rinsed with de-ionized water and stored in the MES buffer at 4° C. prior to use.

Both the two SPR sensors (A) and (B) with DNA probe are applied to detect a dynamic hybridization between DNA probe and its complementary DNA (cDNA) in the analyte. The mobile phase flowing the surface of sensor is a 20 mM phosphate buffer solution (PBS, pH 7.7) containing 300 mM of sodium chloride, 1 mM of EDTA, and 100 mM of urea. The mobile phase is pumped through the surface of the sensor at a flow rate of 50 μm/min and the temperature is controlled at 27° C. After the sensing system is stable, the sample solution containing mobile phase and 1 μm of DNA which sequence is SEQ ID NO: 2 is flowed through the surface of sensor. The mobile phase without DNA is reflowed through the surface of sensor to remove the DNA molecules binding to probe weekly until the ascending trend of the SPR angle shift is tardy or even no SPR angle shift is observed.

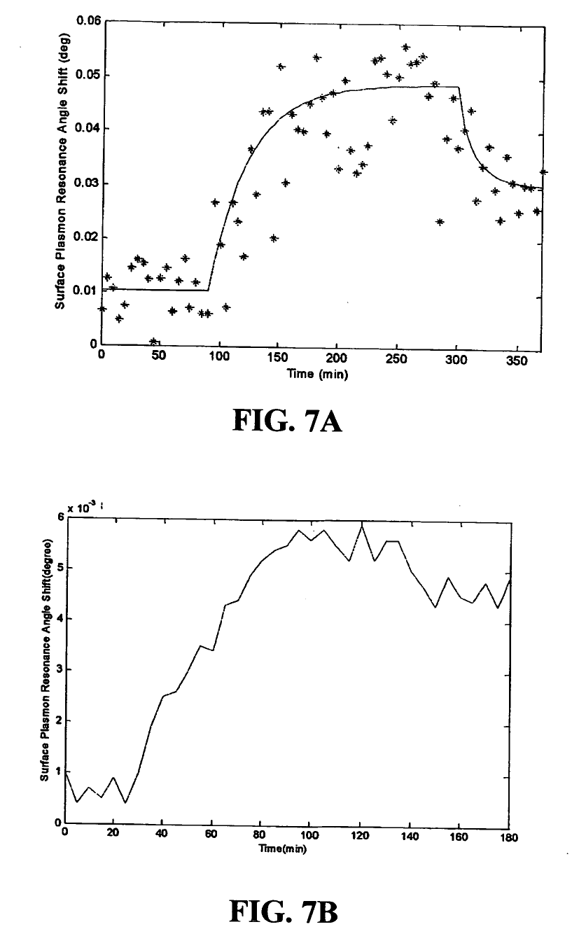

The result for detection of DNA hybridization with the two SPR sensor is illustrated in FIG. 7. A large SPR angle shift is observed in FIG. 7A to detect DNA hybridization with SPR sensor (A), it is about 10 times of the SPR angle shift of conventional SPR sensor (B) (shown in FIG. 7B). The result shows that the sensitivity of detection using the SPR sensor of the present invention can be advanced one order in sensing biomolecules.

What is claimed is:

1. A surface plasmon resonance sensor comprising:
a prism having a surface on which a metallic layer is coated;
a metallic nanoparticle layer formed on the metallic layer;
a light source giving off a light to the prism, the light being reflected by the surface of the prism to form a reflected light; and
a light detector for detecting the reflected light.

2. The surface plasmon resonance sensor according to claim 1 further comprising a dielectric layer coated on the metallic nanoparticle layer.

3. The surface plasmon resonance sensor according to claim 1, wherein the light source comprises a semiconductor laser array for radiating multiple laser beams, a polarizing device and a half-wave plate for adjusting polarized components of the laser beams.

4. The surface plasmon resonance sensor according to claim 1 further comprising a spectral prism for splitting the reflected light into polarized transverse magnetic light wave and transverse electric light wave.

5. The surface plasmon resonance sensor according to claim 1, wherein the metallic layer comprises gold.

6. The surface plasmon resonance sensor according to claim 1, wherein the metallic layer comprises silver.

7. The surface plasmon resonance sensor according to claim 1, wherein the metallic layer has a thickness of approximately 50 nm.

8. The surface plasmon resonance sensor according to claim 1, wherein the metallic nanoparticle layer comprises at least nanometer order grains selected from a group consisting of gold, silver and platinum.

9. The surface plasmon resonance sensor according to claim 1, wherein the metallic nanoparticle layer comprises nanoparticle having a diameter of approximately 1-50 nm.

10. The surface plasmon resonance sensor according to claim 1, wherein the metallic nanoparticle layer has a thickness of approximately 1-50 nm.

11. The surface plasmon resonance sensor according to claim 1, wherein the metallic nanoparticle layer is formed by means of co-sputtering.

12. The surface plasmon resonance sensor according to claim 8, wherein the metallic nanoparticle layer comprises a material selected form a group consisting of polymethyl methacrylate (PMMA) and silicon oxide.

13. The surface plasmon resonance sensor according to claim 1 further comprising a self assembled monolayer adjacent the metallic nanoparticle layer.

14. The surface plasmon resonance sensor according to claim 13, wherein the self-assembled monolayer comprises at least one of functional groups and molecule selected from a group consisting of SH, NH₂, CHO, COOH, and Biotin.

15. A method for detecting properties of substance by using a surface plasmon resonance sensor, the method comprising the following steps:
(a) preparing a surface plasmon resonance sensor comprising a prism having a surface on which a metallic layer is coated, a metallic nanoparticle layer formed on the metallic layer, a light source giving off a light to the prism, the light being reflected by the surface of the prism to form a reflected light and a light detector for detecting the reflected light;
(b) preparing a self-assembled monolayer on surface of the metallic nanoparticle layer of the surface plasmon resonance sensor;
(c) preparing a sensing layer immobilized onto the self assembled monolayer for reacting with said; and
(d) contacting said substance with the sensing layer.

16. A method for detecting properties of substance by using the surface plasmon resonance sensor, the method comprising the following steps:
(a) preparing a surface plasmon resonance sensor comprising a prism having a surface on which a metallic layer is coated, a metallic nanoparticle layer formed on the metallic layer, a light source comprising a semiconductor laser array for radiating multiple laser beams, a polarizing device and a half-wave plate for adjusting polarized components of the laser beams, and light detector for detecting a reflected light formed by reflecting the laser beams by the surface of the prism;
(b) preparing a self-assembled monolayer on surface of the metallic nanoparticle layer of the surface plasmon resonance sensor;
(c) preparing a sensing layer immobilized onto the self assembled monolayer for reacting with said; and
(d) contacting said substance with the sensing layer.

17. A method for detecting properties of substance by using the surface plasmon resonance sensor, the method comprising the following steps:
(a) preparing a surface plasmon resonance sensor comprising a prism having a surface on which a metallic layer is coated, a metallic nanoparticle layer formed on the metallic layer, a light source giving off a light to the prism, the light being reflected by the surface of the prism to form a reflected light, a spectral prism for splitting the reflected light into polarized transverse magnetic light and transverse electric light wave and a light detector for detecting the polarized waves;
(b) preparing a self-assembled monolayer on surface of the metallic nanoparticle layer of the surface plasmon resonance sensor;
(c) preparing a sensing layer immobilized onto the self assembled monolayer for reacting with said; and
(d) contacting said substance with the sensing layer.
